(19) United States
(12) Patent Application Publication
(10) Pub. No.: US 2025/0128438 A1
(43) Pub. Date: Apr. 24, 2025

(54) FOLDING KNIFE LOCKING STRUCTURE

(71) Applicant: Siqi Wang, Zhuhai (CN)

(72) Inventor: Siqi Wang, Zhuhai (CN)

(21) Appl. No.: 19/009,929

(22) Filed: Jan. 4, 2025

Related U.S. Application Data
(63) Continuation of application No. PCT/CN2024/115624, filed on Aug. 29, 2024.

(51) Int. Cl. B26B 1/04

(52) U.S. Cl. CPC B26B 1/046

(57) ABSTRACT

A folding knife locking structure which comprises a locking bridge, a button washer, a screw washer, a button, a spindle, a spindle screw, a locking spring and a button spring is disclosed. The locking bridge of the invention can be pushed by the locking spring and automatically inserted into a locking groove or a closing groove arranged on a cutting edge according to a rotation angle of the cutting edge, so as to automatically achieve a locking effect. A locking contact surface is arranged on the locking bridge and is divided into a flat section and an inclined section with different angles, thereby achieving double effects of wear compensation and locking insurance. The operation of manual safety is not needed. The invention has the advantages of control convenience and locking firmness. An operation gesture does not need a finger to appear on a return path of the cutting edge.

### TECHNICAL FIELD

The present invention relates to the field of folding knives, and more particularly to a folding knife locking structure.

### BACKGROUND

A folding knife with locking structure is a common production and living tool. A blade can rotate in a certain angle range. When the blade is stretched to a maximum angle, the locking structure automatically ejects and locks the blade, which is convenient for users to use. The locking structure is provided with an unlocking switch which can be operated by a finger for unlocking to rotate and store the blade into a handle. This folding knife has the advantages of small storage space and integration of the handle and a sheath. With the development of productivity and the improvement of living standards of people, higher requirements have been put forward for tools from “usable” to “easy to use”. In the field of the folding knife, there are several common categories of user needs.

Control convenience: One-handed operation can be conducted in a comfortable gesture to control the expansion, unlocking and closing of the blade. It is better if it feels smooth and not sluggish in the process.

Locking firmness: When vigorously used, the locking structure will not cause the blade to return and hurt the hand due to breaking or slipping. Some folding knives will be added with a second manual safety lock or latch in addition to the automatic locking, which can improve the degree of firmness, but violate the need for control convenience.

Misoperation prevention: In normal use, the blade may not return and hurt the hand due to unintended contact of the unlocking switch. In normal unlocking, the hand may not be hurt because the finger is on a blade return path. In storage, people or items may not be hurt by accidental expansion of the blade due to the vibration of walking or transportation.

Simplicity and beauty: Each locking structure, especially the unlocking switch, will inevitably increase bulges or breaks on the structure. The bulges are generally used for a finger to press the unlocking switch, and the specific expression form of the breaks includes a screw, a hole, a groove, a block joint, etc. Users who pursue simplicity and beauty hope these bulges or breaks as few as possible, as small as possible, and preferably hidden from view.

Space saving: The locking structure inevitably occupies a certain space and conflicts with the blade. The larger the volume of the locking structure is, the more the area is exposed when the blade is closed, or the blade shall be made to avoid a gap, and the length of the available cutting edge will be lost. Users will hope to waste as little space as possible.

In the current market, there are many popular locking structures, such as liner locks, lockbacks, shaft locks, etc., wherein the liner lock is the most popular locking structure, which has the advantages of control convenience, simplicity and beauty, and space saving, but has disadvantages in the aspects of locking firmness and misoperation prevention. The lockback may be the best on the market in the aspect of locking firmness, but has obvious disadvantages in the aspects of control convenience, misoperation prevention and space saving. The shaft lock is good in the aspects of control convenience, locking firmness and misoperation prevention, but has disadvantages in the aspects of simplicity and beauty, and space saving. These popular locking structures have own merits for the above needs, but there is no locking structure that can satisfy customer requirements in all of the above aspects.

Therefore, the present invention specially provides a locking structure which can satisfy the customer requirements in the current market in the aspects of control convenience, locking firmness, misoperation prevention, simplicity and beauty, and space saving.

### SUMMARY

### 1. Technical Problem to be Solved

Aiming at the problems existing in the prior art, a purpose of the present invention is to provide a folding knife locking structure, which can solve the problem that the existing locking structure cannot satisfy the user needs of control convenience, locking firmness, misoperation prevention, simplicity and beauty, and space saving.

### 2. Technical Solution

To solve the above problem, the present invention adopts the following technical solution.

A folding knife locking structure comprises a locking bridge, a button washer, a screw washer, a button, a spindle, a spindle screw, a locking spring and a button spring; a threaded hole channel is arranged in the middle of the spindle; the button washer is in threaded connection with an upper end of the spindle; and the screw washer is arranged at a lower end of the spindle through the spindle screw.

One end of the button penetrates through the button washer and extends into the threaded hole channel of the spindle; the button spring is arranged in the threaded hole channel between the button and the spindle screw; a side edge of the button washer is provided with an avoidance hole; the screw washer is provided with a placement hole of the locking spring; the placement hole of the locking spring is provided with the locking spring; both ends of the locking bridge are respectively provided with a first contact block clamped into the button washer and coming into contact with the button through the avoidance hole, and a second contact block clamped at the other end of the locking spring; and both sides of the locking bridge are respectively provided with a locking contact surface fitted with a locking groove of a cutting edge, and a closing contact surface fitted with a closing groove of the cutting edge.

Through the above structure, by pressing the button, the button is downward relative to the button washer, thereby driving the locking bridge to move downward. Thus, the position of the locking bridge is changed. The locking contact surface of the locking bridge is separated from the locking groove of the cutting edge, so that the cutting edge can rotate around a handle and can be folded or unfolded. The blade is not subjected to direct or indirect pressure from any spring when rotating. Therefore, the frictional resistance is very small, and one-handed operation can be conducted, without the need of assisting in rotating the blade by the other hand, thereby playing a role of control convenience. At the same time, because pressing the button does not require the finger to appear on the return path of the cutting edge, hands can be prevented from being hurt, thereby playing a role of misoperation prevention. In the process of pressing, the button and the locking bridge squeeze the button spring and the locking spring respectively, but after an external force is released, the button and the locking bridge return to original positions under the action of an elastic force. The locking bridge can conduct locking through the locking contact surface fitted with the locking groove of the cutting edge, or provides a certain threshold of closing resistance through the closing contact surface fitted with the closing groove of the cutting edge according to a state of folding or unfolding. Thus, in storage, people or items may not be hurt by accidental expansion of the blade due to the vibration of walking or transportation. Preferably, an extension end of the button is provided with a groove, and the groove is provided with a clamping rubber ring used for fixing the button and having an extension end arranged at the threaded hole channel of the spindle; and an inner step for clamping the clamping rubber ring is arranged in a middle of the button washer.

It can be seen that the extension end of the button is provided with the groove, the clamping rubber ring is arranged and the inner step is matched, so that the position of the button is fixed, without affecting the use of the button. The structure is simple, and the manufacturing cost is low.

Preferably, an upper surface of the button washer is provided with a first groove fitted with the size of the button, a button extension end hole is formed in the first groove, and a side edge of the first groove is also provided with a locking bridge contact break for contact between the locking bridge and the button.

It can be seen that through the first groove fitted with the size of the button, the button can be arranged in the button washer. The locking bridge contact break makes the button come into contact with the first contact block of the locking bridge. The overall structure is completely hidden in the handle. The appearance of the overall structure is more beautiful. At the same time, the break plays a role of matching with the handle to prevent the button washer from rotating. The rotation of the button washer is avoided, which may cause the problem that friction is generated with the movement of the locking bridge and the normal use is affected. The button is flush with the button washer, which is not only beautiful, but also plays a role of misoperation prevention. If no hard ring provides protection around the button, it is easy to cause unintended contact in use, which may unlock the blade and accidentally hurt the finger. After the protective ring is added, because a mouth is small and the hole is deep, only a fingertip can reach in the hole and press to a depth required for unlocking, and the blade cannot be unlocked by other ways, thereby solving the problem of hurting the hands by unintended contact.

Preferably, a ring is protruded in the middle of the screw washer; a hole of the spindle, through which the spindle penetrates, is also arranged; and a side edge of the protruded ring is provided with an arc break for matching the handle and the locking spring.

It can be seen that the arc break is convenient to fix the locking spring and fix the handle. The overall structure is completely hidden in the upper and lower handles. The overall structure is simple and beautiful. The arc break also plays a role of rotation prevention.

Preferably, an upper gasket and a lower gasket are arranged above and below an outer end of the spindle respectively; a cutting edge setting region is formed between the upper gasket and the lower gasket; an upper handle fixing region is formed between the upper gasket and the button washer; and a lower handle fixing region is formed between the lower gasket and the screw washer.

It can be seen that the cutting edge setting region, the upper handle fixing region and the lower handle fixing region are formed through the upper gasket and the lower gasket which are fixed, so that the overall structure is completely hidden in the handles, and the appearance of the overall structure is more beautiful.

The present invention has the following technical advantages:

The locking structure of the present invention is fastened by only one spindle screw, has no specific structure exposed in appearance, and has the advantages of simplicity and beauty.

The button of the present invention returns to the original position after releasing. Compared with the locking structure which places the button on the spindle on the market, some buttons of this structure move together with the parts that play a role of locking, causing that the button is in a depressed position in use and the appearance is not perfect. The button of the present invention is always in a perfectly flush position, and the appearance is more beautiful.

The present invention adopts the mode that the arch locking bridge bypasses an outer ring of the blade, so that a distance between the locking contact surface and the center of the circle is maximized as far as possible, that is, the locking lever is maximized, thereby reducing the locking force under the same external torque and making the locking more firm.

In the present invention, the locking contact surface of the locking bridge is divided into two sections with different angles. One section is flat, and the other section is inclined. The inclined section is a compensation inclined plane, which is a normally used locking contact surface, and provides wear compensation to ensure that there is no gap between the cutting edge and the locking bridge and there is no shake. The flat section is a safe plane, which is not in contact with the cutting edge in a normal state. However, when the cutting edge is impacted by an external force and leads to sliding with the inclined plane, for example, when the cutting edge is stuck and pulled out forcefully in the process of cutting wood in the field, the cutting edge slides to an end of the inclined plane and generates a plane, which blocks the return path of the cutting edge. Due to planar contact, the component of the pressure of the cutting edge on the locking bridge in the translation direction of the locking bridge is suddenly changed to 0 (the component on the inclined plane). Thus, the locking bridge loses the power of translation and only has the frictional force, so that the locking bridge does not continue to move, thereby ensuring that the cutting edge is locked and does not hurt the hands. The two locking surfaces play a role equivalent to the manual insurance added by some folding knives on the market. However, this solution is fully automatic. At the same time, the needs of operation convenience and locking firmness are satisfied.

The present invention can conduct one-handed operation in a comfortable gesture to control the expansion, unlocking and closing of the blade. The frictional force is small and the hand feel of operation is smooth in the process. The present invention has the advantage of control convenience.

The present invention has the advantage of misoperation prevention in many aspects that the present invention has closing resistance to prevent vibration and unintended opening of the blade during closing, has the protective ring surrounding the button to prevent unintended contact during expansion and prevents the finger from appearing on the return path of the cutting edge to prevent injury to the hand during unlocking.

The appearance assembled by the parts of the button, the button washer, the spindle, the spindle screw and the screw washer in the present invention is indistinguishable from a common folding knife spindle structure, and no additional space is occupied. The rubber ring, the button spring and the locking spring are completely hidden inside from view, and no additional space is occupied. The locking bridge is in a semi-hidden state, and can only be seen from a specific angle. Moreover, there is no interference with a use part of the cutting edge that is exposed outside the handle, and all effects are hidden in a very small range inside the handle, thereby playing a role of space saving.

### DESCRIPTION OF DRAWINGS

FIG. 1 is a schematic diagram of an overall structure of a locking structure in the present embodiment.

FIG. 2 is a main view of an overall structure of a locking structure in the present embodiment.

FIG. 3 is an A-A sectional view of FIG. 2.

FIG. 4 is a structural schematic diagram of a folding knife in the present embodiment.

FIG. 5 is an exploded schematic diagram of a folding knife in the present embodiment.

FIG. 6 is a structural schematic diagram of a button in the present embodiment.

FIG. 7 is a top view of a button washer in the present embodiment.

FIG. 8 is a structural schematic diagram of a button washer in the present embodiment.

FIG. 9 is a schematic diagram of a front and a back of a lower handle in the present embodiment.

FIG. 10 is a structural schematic diagram of a screw washer in the present embodiment.

FIG. 11 is a top view of a screw washer in the present embodiment.

FIG. 12 is a structural schematic diagram of a cutting edge in the present embodiment.

FIG. 13 is a structural schematic diagram of a locking bridge in the present embodiment.

FIG. 14 is a top view of a locking bridge in the present embodiment.

### DETAILED DESCRIPTION

The technical solutions in the embodiments of the present invention will be clearly and fully described below in combination with the drawings in the embodiments of the present invention. Apparently, the described embodiments are merely part of the embodiments of the present invention, not all of the embodiments. Based on the embodiments in the present invention, all other embodiments obtained by those ordinary skilled in the art without contributing creative labor will belong to the protection scope of the present invention. Embodiments

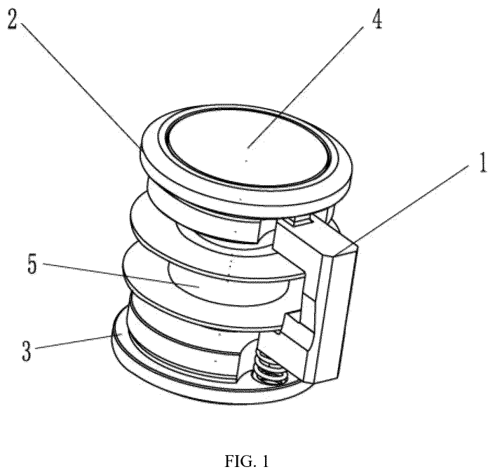

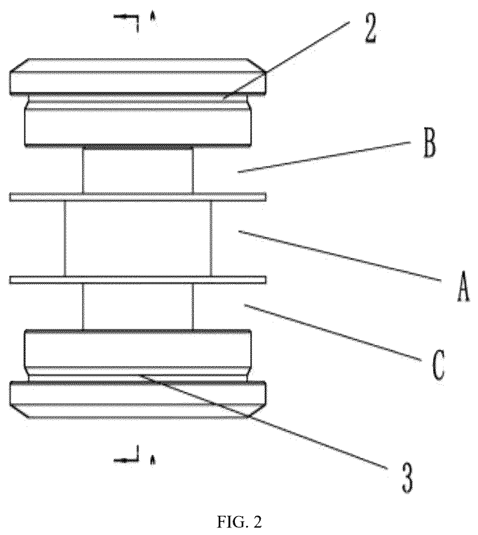

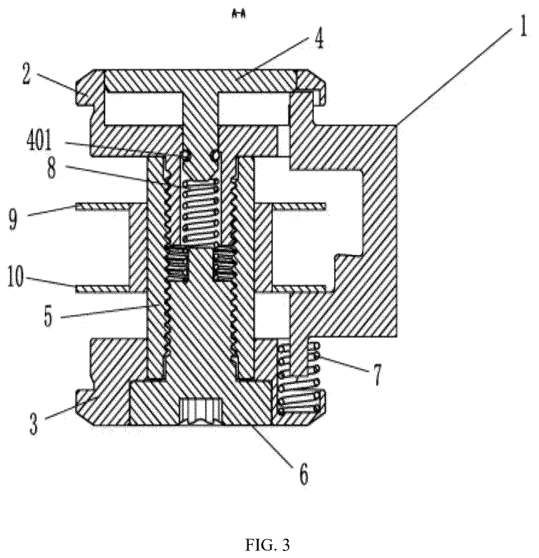

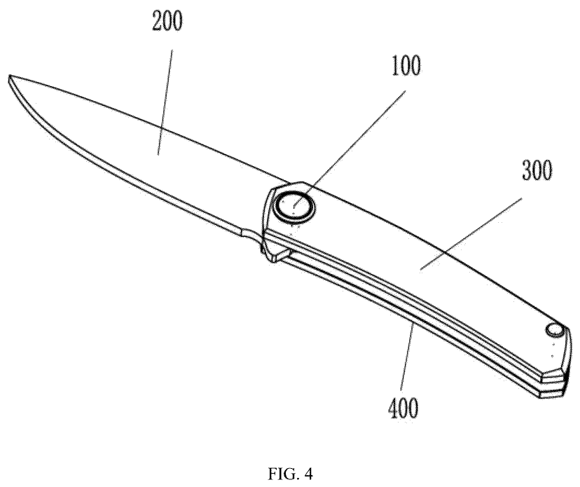

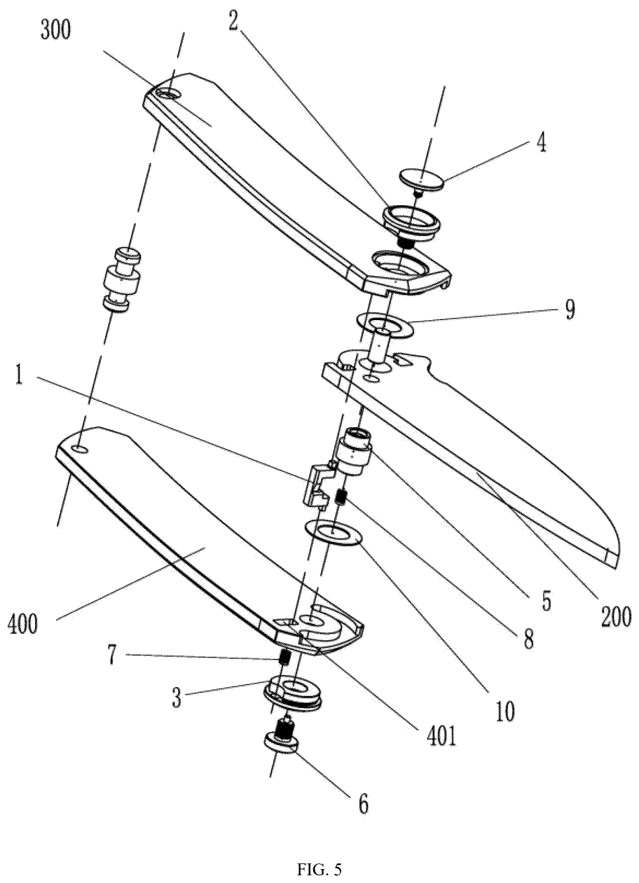

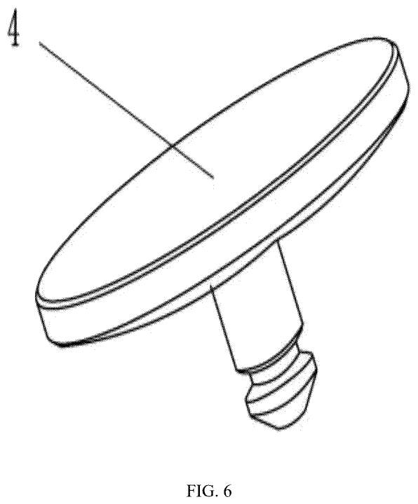

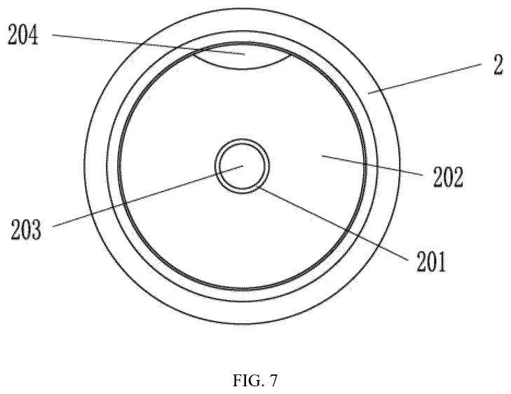

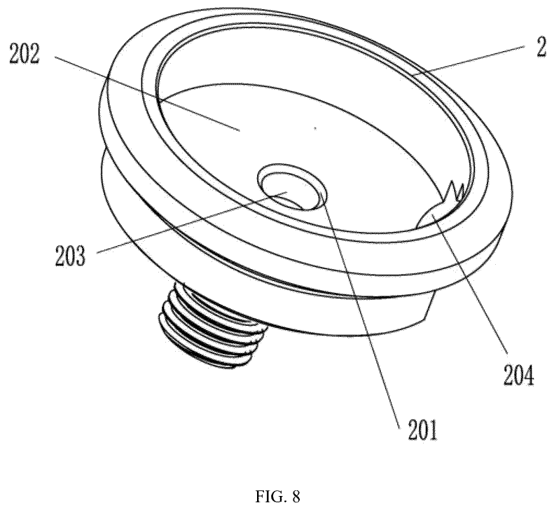

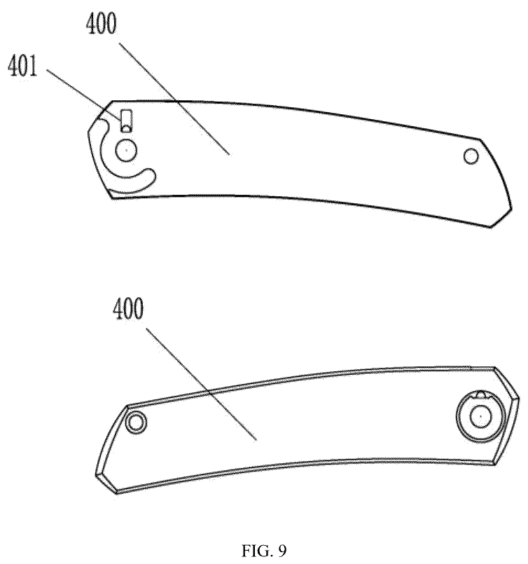

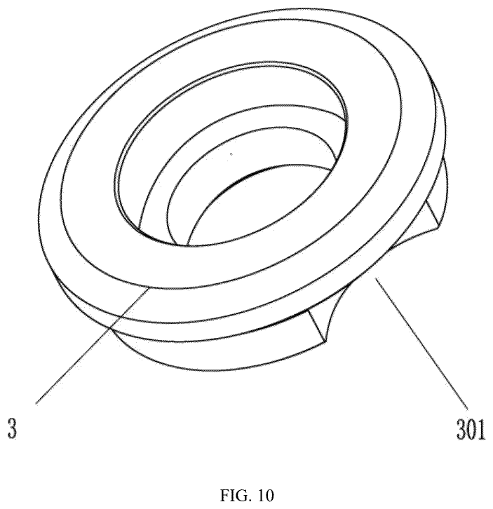

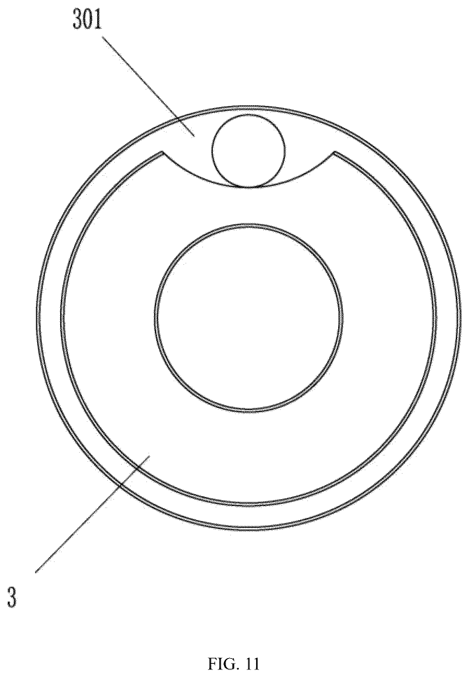

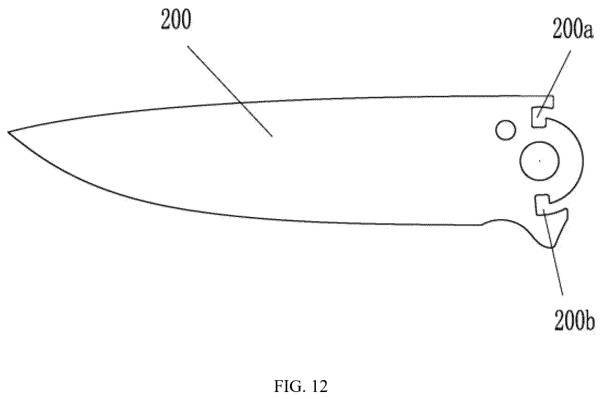

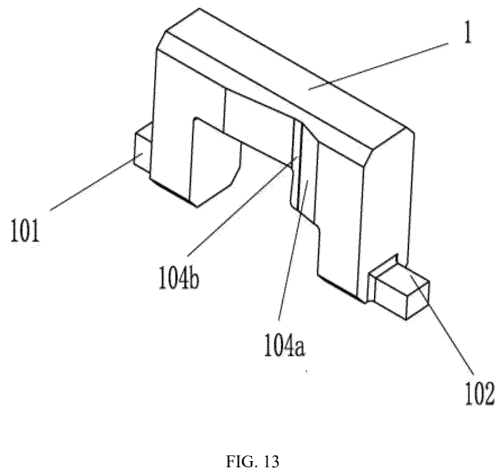

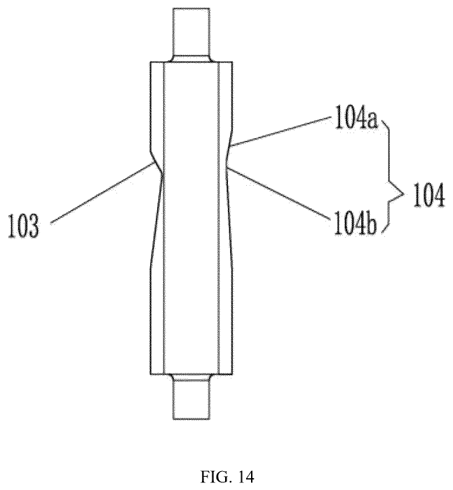

By referring to FIGS. 1-14, a folding knife locking structure 100 is shown. The locking structure 100 comprises a locking bridge 1, a button washer 2, a screw washer 3, a button 4, a spindle 5, a spindle screw 6, a locking spring 7 and a button spring 8; a threaded hole channel is arranged in the middle of the spindle 5; the button washer 2 is in threaded connection with an upper end of the spindle 5; and the screw washer 3 is arranged at a lower end of the spindle 5 through the spindle screw 6.

One end of the button 4 penetrates through the button washer 2 and extends into the threaded hole channel of the spindle 5; the button spring 8 is arranged in the threaded hole channel between the button 4 and the spindle screw 6; a side edge of the button washer 2 is provided with an avoidance hole; the screw washer 3 is provided with a placement hole of the locking spring 7; the placement hole of the locking spring 7 is provided with the locking spring 7; both ends of the locking bridge 1 are respectively provided with a first contact block 101 clamped into the button washer 2 and coming into contact with the button 4 through the avoidance hole, and a second contact block 102 clamped at the other end of the locking spring 7; and both sides of the locking bridge 1 are respectively provided with a locking contact surface 104 for clamping a locking groove 200a of a cutting edge 200, and a closing contact surface 103 for clamping a closing groove 200b of the cutting edge 200.

Preferably, an extension end of the button 4 is provided with a groove, and the groove is provided with a clamping rubber ring 401 used for fixing the button 4 and having an extension end arranged at the threaded hole channel of the spindle 5; and an inner step 201 for clamping the clamping rubber ring 401 is arranged in a middle of the button washer 2.

Preferably, an upper surface of the button washer 2 is provided with a first groove 202 fitted with the size of the button 4, a button extension end hole 203 is formed in the first groove 202, and a side edge of the first groove 202 is also provided with a locking bridge contact break 204 for contact between the locking bridge 1 and the button 4.

Preferably, a ring is protruded in the middle of the screw washer 3; a hole of the spindle 5, through which the spindle 5 penetrates, is also arranged; and a side edge of the protruded ring is provided with an arc break 301 for matching the handle and the locking spring 7.

Preferably, an upper gasket 9 and a lower gasket 10 are arranged above and below an outer end of the spindle 5 respectively; a cutting edge setting region A is formed between the upper gasket 9 and the lower gasket 10; an upper handle fixing region B is formed between the upper gasket 9 and the button washer 2; and a lower handle fixing region C is formed between the lower gasket 10 and the screw washer 3.

In the present embodiment, the locking bridge is confined within a pair of rectangular holes 401 arranged symmetrically on the inner side of the handle and can slide only in one direction.

In the present embodiment, the locking contact surface 104 of the locking bridge 1 is divided into two sections with different angles. One section is flat, and the other section is inclined. The inclined section is a compensation inclined plane 104a, which is a normally used locking contact surface 104, and provides wear compensation to ensure that there is no gap between the cutting edge 200 and the locking bridge 1 and there is no shake. The flat section is a safe plane 104b, which is not in contact with the cutting edge 200 in a normal state. However, when the cutting edge 200 is impacted by an external force and leads to sliding with the inclined plane, for example, when the cutting edge is stuck and pulled out forcefully in the process of cutting wood in the field, the cutting edge slides to an end of the inclined plane and generates a plane, which blocks the return path of the cutting edge 200. Due to planar contact, the component of the pressure of the cutting edge 200 on the locking bridge 1 in the translation direction of the locking bridge is suddenly changed to 0 (the component on the inclined plane). Thus, the locking bridge 1 loses the power of translation and only has the frictional force, so that the locking bridge does not continue to move, thereby ensuring that the cutting edge 200 is locked and does not hurt the hands. Compared with an ordinary folding knife, the present invention avoids the problem that the cutting edge 200 returns to hurt the hands due to unlocking under the same circumstances.

Specific implementation: In the present embodiment, the cutting edge 200 is arranged on the spindle 5 between the upper gasket 9 and the lower gasket 10 through the cutting edge setting region A; an upper handle 300 and a lower handle 400 are fixed to the upper handle fixing region B and the lower handle fixing region C respectively; and the cutting edge 200 is provided with an exposed part for operation of a finger to push the cutting edge 200 to rotate around the spindle 5. It is worth noting that the exposed part of the cutting edge comprises a convex block, a nail groove, a hole, a push button, a push disk and other ways.

A stop post is also arranged among the upper handle 300, the lower handle 400 and the cutting edge 200 for blocking the cutting edge 200 from rotating anticlockwise. The stop post belongs to the prior art. A specific structure and working principle will not be repeated in the present application, and in the present embodiment, the upper handle 300 and the lower handle 400 are mirror structures.

In the present embodiment, the folding knife is initially in a closed state. At this time, in the closed state, on the one hand, the counterclockwise rotation of the cutting edge 200 is blocked by the stop post; and on the other hand, the locking bridge 1 is pushed by the locking spring 7 to enter the closing groove of the cutting edge 200 to block the clockwise rotation of the cutting edge 200. The resistance in two directions limits the cutting edge 200 in a fixed position, but the resistance of the locking bridge 1 is provided by the closing contact surface 103, and the locking bridge can be pushed apart only by a force provided by a finger above a certain threshold.

At this time, the locking bridge 1 is not in contact with the button 4. The button 4 is pushed by the button spring 8 to be flush with the surface of the button washer 2. At this time, the continued movement of the button 4 is restricted by the clamping rubber ring 401 and may not be ejected from the button washer 2, which is a normal state of the button 4. When not pressed by a finger, the button 4 is always restricted by the button spring 8 and the rubber ring to stop in a position flush with the button washer 2.

By pressing the button 4, the locking bridge 1 does not restrict the cutting edge 200, or the finger provides a force above a certain threshold to drive the cutting edge 200 to rotate around the spindle 5. In this intermediate state, the locking bridge 1 is not fixed in the closing groove 200b of the cutting edge 200 or the locking groove 200a of the cutting edge 200. Thus, the cutting edge 200 can freely rotate clockwise or counterclockwise.

After the cutting edge 200 is rotated and expanded, an expanded locking state is formed. In this state, on the one hand, the clockwise rotation of the cutting edge 200 is blocked by the stop post; and on the other hand, the locking bridge 1 is pushed by the locking spring 7 to enter the locking groove 200a of the cutting edge 200 to block the counterclockwise rotation of the cutting edge 200. The resistance in two directions limits the cutting edge in a fixed expanded position. Different from the closed state, the slope of the locking contact surface 104 is very small at this time, and a self-locking condition of a frictional angle is achieved, making the locking very firm.

When closure for storage is required, the button 4 needs to be pressed to cancel the restriction of the locking bridge 1 and form an expanded unlocking state, so that the cutting edge 200 can rotate freely to enter the intermediate state and return to the closed state to complete the storage.

The difference between the expanded unlocking state and the expanded locking state depends entirely on whether the button 4 is pressed. When the button 4 is not pressed, this is a locking state and the blade cannot rotate; and when the button 4 is pressed, the blade can rotate freely to enter the intermediate state and return to the closed state to complete the storage.

In the present invention, the folding knife locking structure 100 is perfectly integrated into the spindle screw 6 without adding any appearance-specific locking structure 100. Compared with other locking structures 100 which have additional buttons 4, or have additional slots, or have additional screws, the present invention is more simple and beautiful.

It is worth noting that the upper gasket and the lower gasket can be replaced with structures such as thrust ball bearings that can form a cutting edge setting region, which belongs to the prior art for those skilled in the art. The equivalent replacement of the structure can be achieved by simple replacement. The above only describes the specific preferred embodiments of the present invention, but the protection scope of the present invention is not limited thereto. Any equivalent replacement or change made by those skilled in the art familiar with the technical field within the technical scope disclosed by the present invention according to the technical solution and the improved conception of the present invention shall be covered within the protection scope of the present invention.

What is claimed is:

1. A folding knife locking structure, comprising a locking bridge, a button washer, a screw washer, a button, a spindle, a spindle screw, a locking spring and a button spring;
wherein a threaded hole channel is arranged in a middle of the spindle; the button washer is in threaded connection with an upper end of the spindle; and the screw washer is arranged at a lower end of the spindle through the spindle screw;
one end of the button penetrates through the button washer and extends into the threaded hole channel of the spindle; and the button spring is arranged in the threaded hole channel between the button and the spindle screw;
a side edge of the button washer is provided with an avoidance hole; the screw washer is provided with a placement hole of the locking spring; and the placement hole of the locking spring is provided with the locking spring;
both ends of the locking bridge are respectively provided with a first contact block clamped into the button washer and coming into contact with the button through the avoidance hole, and a second contact block clamped at the other end of the locking spring;
both sides of the locking bridge are respectively provided with a locking contact surface for clamping a locking groove of a cutting edge, and a closing contact surface for clamping a closing groove of the cutting edge;
the locking contact surface is divided into a flat section and an inclined section.

2. The folding knife locking structure according to claim 1, wherein an extension end of the button is provided with a groove, and the groove is provided with a clamping rubber ring used for fixing the button and having an extension end arranged at the threaded hole channel of the spindle; and an inner step for clamping the clamping rubber ring is arranged in a middle of the button washer.

3. The folding knife locking structure according to claim 1, wherein an upper surface of the button washer is provided with a first groove fitted with the size of the button, a button extension end hole is formed in the first groove, and a side edge of the first groove is also provided with a locking bridge contact break for contact between the locking bridge and the button.

4. The folding knife locking structure according to claim 1, wherein a ring is protruded in the middle of the screw washer; a hole of the spindle, through which the spindle penetrates, is also arranged; and a side edge of the protruded ring is provided with an arc break for matching the handle and the locking spring.

5. The folding knife locking structure according to claim 1, wherein an upper gasket and a lower gasket are arranged above and below an outer end of the spindle respectively; a cutting edge setting region is formed between the upper gasket and the lower gasket; an upper handle fixing region is formed between the upper gasket and the button washer, and a lower handle fixing region is formed between the lower gasket and the screw washer.
